(19) United States
(12) Patent Application Publication
(10) Pub. No.: US 2009/0096227 A1
(43) Pub. Date: Apr. 16, 2009

(54) Waste collection device

(76) Inventors: Robert Gordon Pender, Brantford, CA (US); Brenda Marie Cameron, Simcoe, CA (US)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(21) Appl. No.: 12/285,758

(22) Filed: Oct. 14, 2008

Related U.S. Application Data
(60) Provisional application No. 60/998,736, filed on Oct. 15, 2007.

(51) Int. Cl. A01K 29/00; A01K 23/00

(52) U.S. Cl. 294/1.5

(57) ABSTRACT

A device for collecting pet waste comprising a shaft having an upper end and a lower end; and a receptacle support pivotally attached to the lower end of the shaft, said support being moveable between a closed position in which the receptacle support is adjacent to the shaft and a plurality of open waste-receiving positions in which the receptacle support is spaced from the shaft at an angle to the shaft.

### FIELD OF THE INVENTION

The present invention relates generally to a device for collecting waste, such as pet feces, and in particular, relates to a portable waste collecting device adapted to collect the feces before it touches the ground.

### BACKGROUND OF THE INVENTION

The requirement to clean up after your pet has long been in existence to maintain the cleanliness of public areas such as sidewalks and parks, as well as private property bordering such public areas. In fact, in some urban areas, health concerns have resulted in the levy of fines to pet owners who allow pet feces to drop to the ground, contaminating the immediate area and potentially surrounding areas as a result of water runoff.

A number of devices to assist in the clean-up of pet feces have been proposed. For example, U.S. Pat. No. 3,777,708 to Vogt describes a disposal mechanism comprising a telescopic tube member, a flexible steel band retractably mounted at one end of the tube member and a bag member for collecting feces which is attached to the steel band via pockets formed in the edges thereof to receive the steel band.

U.S. Pat. No. 4,852,924 to Ines describes a similar excrement collector comprising a telescopic handle, a circular frame foldably mounted onto the handle and an elastic corded bag for fitting onto the circular frame and collecting the feces. A comparable device is described in U.S. Pat. No. 5,634,678 to Bailey comprising a telescopic handle having a coupling mechanism at one end thereof from which an annular ring extends for holding a collection bag. In both cases, the circular frame/annular ring are mounted and extend from the handle at an angle of about 135°.

Despite the provision in the art of such collection devices, few exist in the market place. Accordingly, it would be desirable to provide a practical device that may readily be used for the purpose for which it was intended and which overcomes at least one of the disadvantages of prior devices.

### SUMMARY OF THE INVENTION

A novel device for collecting pet waste, such as feces, has now been developed comprising a shaft and a receptacle support pivotally mounted at one end of the shaft which is adjustable into a plurality of receiving positions.

Thus, in one aspect, a device for collecting pet waste is provided. The device comprises:

a shaft having an upper end and a lower end; and

a receptacle support pivotally attached to the lower end of the shaft, said support being moveable between a closed position in which the receptacle support is adjacent to the shaft and a plurality of open waste-receiving positions in which the receptacle support is spaced from the shaft at an angle to the shaft.

In another aspect of the invention, a device for collecting pet waste is provided comprising:

a shaft having an upper end and a lower end; and

a receptacle support attached to the lower end of the shaft, said support comprising an annular spline-shaped portion adapted to removeably engage a receptacle thereon.

These and other aspects of the invention are described herein by reference to the following drawings.

### BRIEF DESCRIPTION OF THE DRAWINGS

FIG. 1 is a perspective view of a device according to an embodiment of the invention;

FIG. 2 is a top view (A), side view (B) and perspective view (C) of the device of FIG. 1 in a collapsed storage position;

FIG. 3 illustrates multiple receiving positions of the device of FIG. 1;

FIG. 4 is a magnified view of a mechanism for locking the device into different receiving positions;

FIG. 5 is an expanded view of the receptacle support of the device of FIG. 1; and

FIG. 6 is the device of FIG. 1 in use.

### DETAILED DESCRIPTION OF THE INVENTION

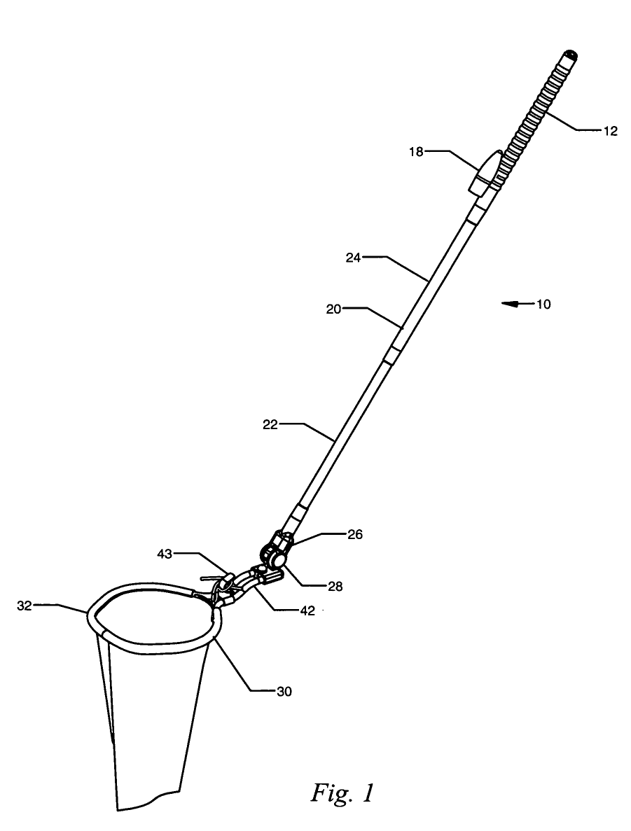

A device 10 for collecting pet waste, such as feces, is provided as generally shown in FIG. 1. The device 10 comprises a shaft 20, at the upper end of which is a handle portion 12 and at the lower end of which is a receptacle support 30 for securing a receptacle, such as bag, suitable to collect the waste.

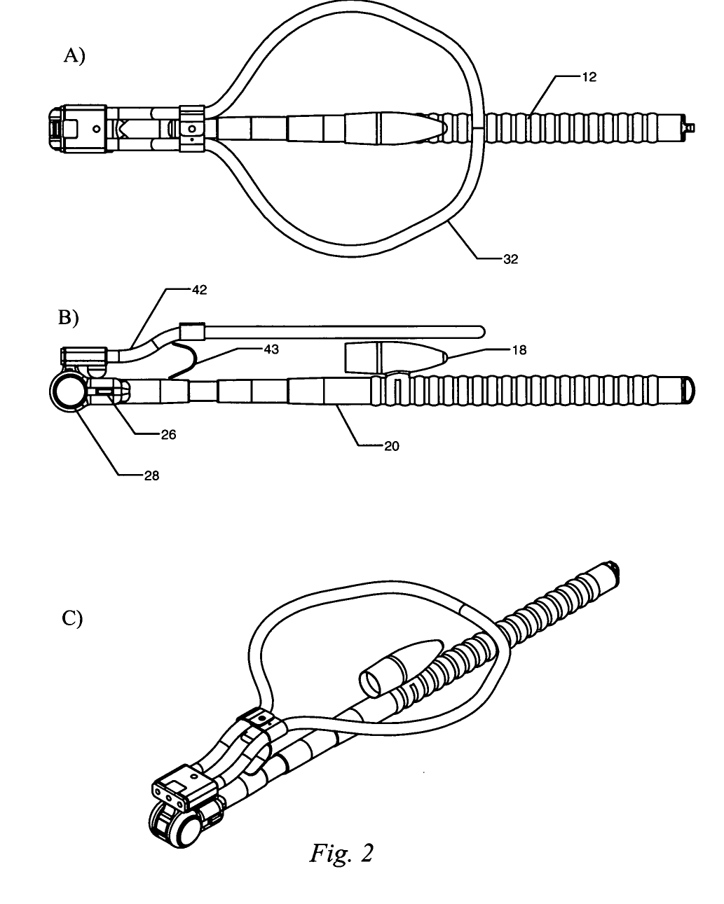

The shaft 20 connects the handle portion 12 to the receptacle support 30. The length and diameter of the shaft 20 are not particularly restricted, but are preferably of a length and diameter that renders the device appropriate to carry when taking a pet for a walk. A suitable diameter of the shaft 20 may be from about 0.12 to about 0.42 inches, for example. The shaft 20 may be made out of any material suitable to provide the required support for the use in which the device 10 is intended, including for example, metal, wood, fibreglass and the like. Preferably, the shaft 20 is made out of a material that renders it lightweight and suitable for carrying on a walk. In one embodiment, the shaft 20 is collapsible to permit ease of handling when not in use, and to permit the convenient storage thereof. In this regard, the shaft 20 may comprise two or more hinged portions that may be folded onto one another in an accordion fashion. As shown in FIG. 1, the shaft 20 may also comprise one or more condensable telescopic portions 22, 24 adapted such that, for example, a lower portion 22 fits or slides within an adjacent upper portion 24, to provide the device in collapsed form as shown in FIG. 2. As will be appreciated by one of skill in the art, the device may include a mechanism to maintain the device in either a collapsed or extended form to prevent undesired or premature collapsing or extension of the shaft. One mechanism useful for this purpose is a spring-loaded cam-activating release mechanism.

The handle portion 12 of the device is at the upper end of the shaft 20. The handle portion 12 may simply be an extension of shaft 20, or may be formed to increase comfort and/or grip. For example, the handle portion 12 may comprise a ribbed portion as shown in FIG. 1, or may take on a comfortable grip conformation, e.g. including finger indentations. Alternatively, or in addition, the handle portion 12 may be formed of or covered with a material which increases comfort and/or grip such as a non-slip rubber or other suitable material. The handle portion 12 may optionally have a looped strap fastened thereto to permit the device to be held conveniently on a user's wrist when not in use.

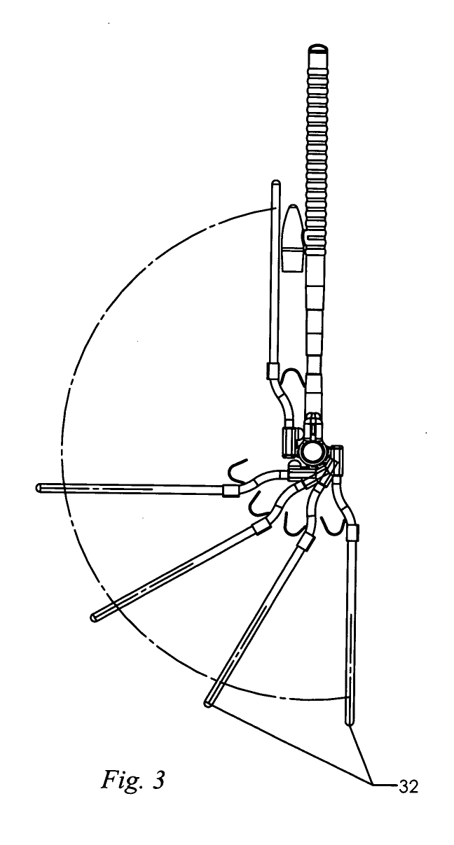

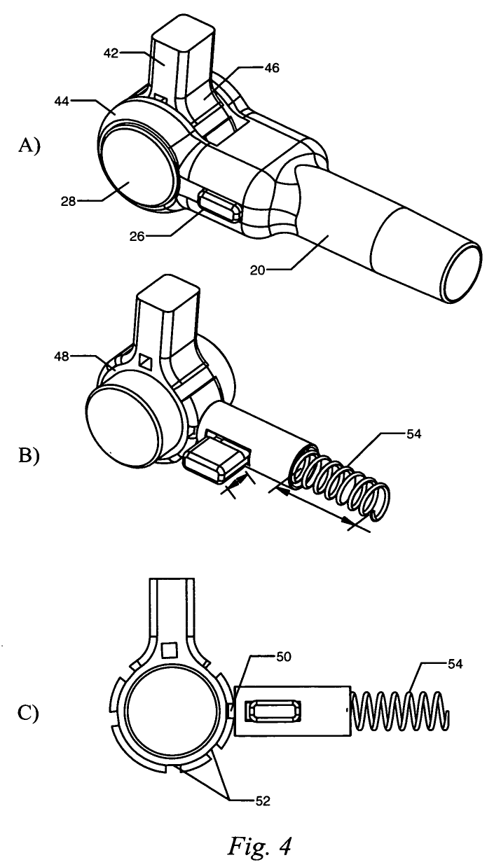

A receptacle support 30, comprising an annular portion 32 and an attachment arm 42, is pivotally attached to the lower end of the shaft 20 via the attachment arm 42. The pivotal connection between the receptacle support 30 and the shaft 20 allows the receptacle support to assume a number of positions relative to the shaft 20, for example a closed positions as shown in FIG. 2 and a plurality of open positions as shown in FIG. 3, thereby providing versatility in the use of device 10. In this regard, as can be seen in FIG. 2 and more particularly in the exploded views of FIG. 4, the lower end of the shaft 20 comprises a pair of annular portions 44 which pivotally embrace either end of a cylindrical body 28 formed at the base of attachment arm 42. The annular portions 34 are separate by a recess 36 adapted to receive the base of the attachment arm 42 which forms a ring 48 surrounding the cylindrical body 28. The ring 48 is fixed relative to the cylindrical body 28.

Incorporated within the device 10 is a locking mechanism adapted to lock the receptacle support 30 in either a closed position, as shown in FIG. 2, in which the receptacle support 30 is folded back into a position adjacent to the shaft 20, or in any one of a plurality of open, receiving positions relative to the shaft 20 as shown in FIG. 3, in which the receptacle support 30 is pivoted from the shaft 20 and sits at an angle thereto. A suitable pivot locking mechanism is illustrated in FIG. 4(B/C). The locking mechanism includes a spring-loaded release pin 50 mounted within the lower end of the shaft 20, located adjacent to the cylindrical body 28 such that the release pin 50 is engageable with a series of receiving cavities 52 spaced about the circumference of the cylindrical body 28 and sized to receive the pin 50. An actuating release button 26, which is exposed to the user at the base of the shaft 20, functions to release the pin 50. Pressing the release button 26 in a direction perpendicular to the shaft 20 results in movement of an angular CAM that forces the pin 50 to move laterally towards a compression spring 54 thereby disengaging the pin 50 from the cavity 52 within which it was seated.

Thus, the release button 26 is pressed to permit the receptacle support 30 to be rotated from a closed position to a desired open receiving position relative to the shaft 20 to use the device 10 and vice versa when a user is finished using the device 10. The provision of a plurality of receiving positions advantageously provides the present device with a versatility that enables a user to accurately, ergonomically and in a sanitary fashion, collect feces from a pet during elimination, thereby avoiding feces contact with the user as well as with the ground and the subsequent contamination that occurs as a result.

The attachment arm 42 of the receptacle support 30 is angled downward toward the annular portion 32 and is integral with the annular portion 32. A hook 43 is fastened to the attachment arm 42 close to the annular portion 32. The angling of the attachment arm 42 accommodates the hook 43, and any other add-on features as will be described, and permits the device to readily assume its closed position as shown in FIG. 2b without being hindered by added features.

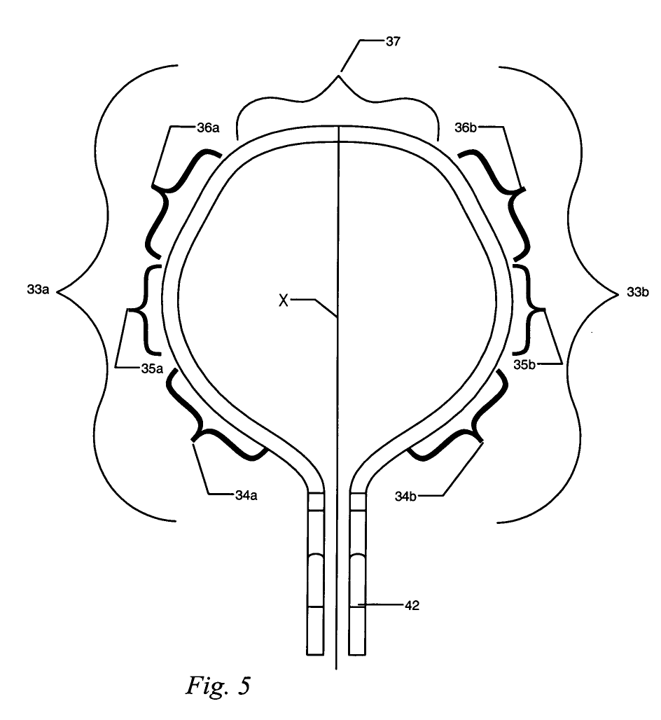

Referring to FIG. 5, the annular portion 32 is spline-shaped so as to removeably engage a receptacle thereon. The shape of the annular portion 32 maintains the receptacle, such as a bag, in place on the annular portion 32 even when containing feces due to the surface tension resulting from the shape of the annular portion 32. In one embodiment, the annular portion 32 comprises a first half 33a and a second half 33b according to line X, the first half being a mirror image of the second half along line X. The first half 33a includes a first proximal segment 34a connected to a first distal segment 36a by a first arc 35a. Similarly, the second half includes a second proximal segment 34b (corresponding to the first proximal segment 34a) connected to a second distal segment 36b (corresponding to the first distal segment 36a) by a second arc 35b (corresponding to the first arc 35a). The first distal segment 36a is connected to the second distal segment 36b by a segment 37 which is substantially perpendicular to the shaft 20. The attachment arm 42 extends into the annular portion 32 at the first and second proximal segments 34a, 34b. The first proximal segment 34a is spaced from the first distal segment 36a by a sharp angle that results in a high surface tension on the backside of the receptacle bag, for example, an obtuse angle in the range of about 92-120°, preferably an angle in the range of 95-115° such as an angle of 100-110°. The second proximal 34b and distal 36b segments are similarly spaced.

The geometrical shape of the annular portion 32 advantageously maintains a feces receiving receptacle, e.g. a bag, in position on the receptacle support 30, and prevents it from slipping off of the support, even when loaded with feces. The bag may also be maintained in position on the annular portion 32 by securing part of the bag, such as one or more handles formed in the bag, a drawstring or a hole formed at a top edge of the bag by the user, onto the hook 43. For optimal results, the size of the receptacle used with the device 10 may require adjustment based on the size of the annular portion 32 of the device. Generally, the annular portion 32 comprises an outside cross-dimension through the centre of X, for example, in the range of about 6-12 inches. In one embodiment, a 9″×11″ bag is appropriate for use with a device 10 having an annular portion 32 with an outside cross-dimension through X in the range of about 6-8 inches.

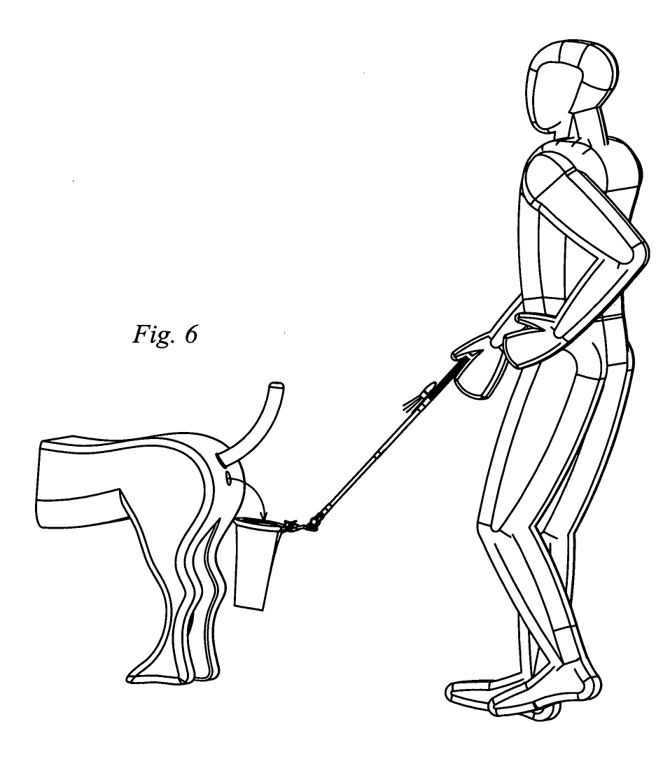

In use, when taking a pet for a walk, the user will carry the device 10 in its collapsed form by handle 12 or by wrist strap 14. When the pet begins to sniff around for a place to defecate, the user will extend the shaft 20, e.g. to its full-length, and open the receptacle support 30 by pressing release button 26. Once the receptacle support 30 is in the desired receiving position, the button 26 is released to lock the receptacle support 30 in the selected receiving position. The annular portion 32 of the receptacle support 30 is fitted, if not already, with a feces-receiving bag which may: be fixed into position on the annular portion 32 by fastening a portion thereof, such as a handle or drawstring, onto hook 43. The user will then place the annular portion 32 containing the bag behind the pet in a position suitable to catch the pet's feces in the bag as they are eliminated as shown in FIG. 6. The bag is then removed from the receptacle support 30 for disposal and a clean bag may be fitted onto the annular portion 32 for the next use. The device may then be collapsed, and the receptacle support put in the closed position using release button 26, for convenient carrying until the next use.

The device may additionally be equipped with additional features to enhance its utility. For example, the device may include a light 18, such as a flashlight, conveniently fastened to the shaft to facilitate use of the device at night. In one embodiment, the light is mounted on or near the handle portion 12 in order that it may readily be turned on/off with the hand holding the device.

The device may also include a bag holder fastened to the shaft, for example, to hold clean bags suitable for mounting onto the receptacle support to replace a bag containing pet waste. The bag holder may take on any appropriate form, including a container with an opening by which to remove a clean bag, and by which to fill the container with clean bags. The holder may also have a hinged door to access the contents thereof or to fill the holder. Such an enclosed holder is additionally useful to hold items such as pet treats, keys, money, and the like when going for a walk.

The foregoing description relates to certain embodiments of the invention; however, as one of skill in the art will appreciate, other embodiments may exist which fall within the scope of the appended claims.

We claim:

1. A device for collecting pet waste comprising:
a shaft having an upper end and a lower end; and
a receptacle support pivotally attached to the lower end of the shaft, said support being moveable between a closed position in which the receptacle support is adjacent to the shaft and a plurality of open waste-receiving positions in which the receptacle support is spaced from the shaft at an angle to the shaft.

2. A device as defined in claim 1, comprising a lock to maintain the receptacle support in a closed or selected waste-receiving position.

3. A device as defined in claim 1, wherein the shaft is collapsible.

4. A device as defined in claim 3, wherein the shaft is telescopic.

5. A device as defined in claim 1, wherein the receptacle support comprises an attachment arm, which is pivotally attached to the shaft, and an annular portion.

6. A device as defined in claim 1, wherein the annular portion has a first half, comprising a first proximal segment connected by an arc to a first distal segment and a second half, comprising a second distal segment connected by an arc to a second proximal segment, wherein said first half is connected to said second half by a segment that is substantially perpendicular to the shaft, said first half being the mirror image of said second half, and each of said first and second proximal segments being positioned to form an angle in the range of 95-110° with the first and second distal segments, respectively.

7. A device as defined in claim 1, wherein the attachment arm and annular portion are integrally formed.

8. A device as defined in claim 1, wherein the receptacle support includes a hook

9. A device as defined in claim 1, comprising a light attached to the shaft.

10. A device as defined in claim 1, comprising a container attached to the shaft.

11. A device for collecting pet waste comprising:
a shaft having an upper end and a lower end; and
a receptacle support attached to the lower end of the shaft, said support comprising an annular spline-shaped portion adapted to removeably engage a receptacle thereon.

12. A device as defined in claim 11, wherein said annular portion comprises a first half comprising a first proximal segment connected by an arc to a first distal segment and a second half, comprising a second distal segment connected by an arc to a second proximal segment, wherein said first half is connected to said second half by a segment that is substantially perpendicular to the shaft, said first half being the mirror image of said second half, and each of said first and second proximal segments being positioned to form an angle in the range of 92-120° with the first and second distal segments, respectively.

13. A device as defined in claim 11, wherein said receptacle support is pivotally attached to the shaft and is moveable between a closed position in which the receptacle support is adjacent to the shaft and a plurality of open waste-receiving positions in which the receptacle support is spaced from the shaft at an angle to the shaft.

14. A device as defined in claim 13, comprising a lock to maintain the receptacle support in a closed or selected waste-receiving position.

15. A device as defined in claim 11, wherein the shaft is collapsible.

16. A device as defined in claim 11, wherein the shaft is telescopic.

17. A device as defined in claim 11, wherein the receptacle support comprises an attachment arm, which is pivotally attached to the shaft, and an annular portion.

18. A device as defined in claim 17, wherein the attachment arm and annular portion are integrally formed.

19. A device as defined in claim 11, wherein the receptacle support includes a hook

20. A device as defined in claim 11, comprising a light attached to the shaft.
